(19) United States
(12) Patent Application Publication
(10) Pub. No.: US 2018/0129298 A1
(43) Pub. Date: May 10, 2018

(54) INPUT DEVICE

(71) Applicant: Jae Hong Park, Seoul (KR)

(72) Inventor: Jae Hong Park, Seoul (KR)

(21) Appl. No.: 15/573,132

(22) PCT Filed: Nov. 7, 2016
(86) PCT No.: PCT/KR2016/012749

§ 371 Date: Nov. 10, 2017

(30) Foreign Application Priority Data
Mar. 18, 2016 (KR) 10-2016-0032441

(51) Int. Cl. G06F 3/02; B41J 5/10

(52) U.S. Cl. CPC G06F 3/0219; H01H 2223/04; B41J 5/10

(57) ABSTRACT

An input device according to the present invention includes: a thumb keyboard part having a plurality of keys provided on a wall surface of an upright wall structure; and four-finger keyboard parts connected to one side of the thumb keyboard part and extending to the other side thereof, and having a plurality of keys provided on the surface thereof. The thumb keyboard part of the upright wall structure is provided at one side of the four-finger keyboard part, and thus the plurality of keys are arranged on an upright wall so as to correspond to the horizontal movement of the thumb such that the utilization of the thumb is maximized, thereby enabling improvements of keyboard input speed and work efficiency to be promoted.

### TECHNICAL FIELD

The present invention relates to an input device, and more specifically, to an input device which allows use of all five finger including a thumb.

### BACKGROUND ART

Generally, a keyboard refers to a device for inputting characters while being connected to a computer and executing various programs of the computer.

A keyboard of such a conventional technique has an integrated keyboard structure extended long horizontally and formed in a structure of executing keyboard work using four fingers excluding the thumb, almost without using the thumb.

However, since a keyboard of the conventional technique has a large size and occupies a large area, it is difficult to place documents, and accordingly, it is inconvenient in that since the documents should be placed on both sides of the keyboard, a worker should do keyboard work while turning the head to one side.

To solve such a problem of the conventional technique, various separable type keyboards that can be separated into two parts are proposed.

Since the separable type keyboard like this may move the keyboard parts to the left and right positions desired by a user, the user may do keyboard work without turning the head by placing a document in a central space between the keyboard parts.

However, there is a problem in that although the left and right separable keyboard is separated in two parts, utilization of the thumb is still low, and the other four fingers are primarily used.

### DISCLOSURE OF INVENTION

Therefore, the present invention has been made in view of the above problem, and it is an object of the present invention to provide an input device, which can equally use all five fingers including a thumb, compared with performing keyboard input work primarily using only four fingers almost without using the thumb, by providing a thumb keyboard part of a upright wall structure at one side of a four-finger keyboard part and arranging a plurality of keys on the upright wall in correspondence to horizontal movement of the thumb to maximize utilization of the thumb.

### Technical Solution

To accomplish the above object, according to one aspect of the present invention, there is provided an input device including: a thumb keyboard part provided with a plurality of keys on a wall surface of an upright wall structure so as to be used only by a thumb; and a four-finger keyboard part connected to one side of the thumb keyboard part, extended to the other direction, and provided with a plurality of keys on the surface so as to be used only by four fingers other than the thumb.

In addition, the input device according to an embodiment of the present invention may further include an auxiliary extension part extended from the bottom of the thumb keyboard part in a direction opposite to the four-finger keyboard part and provided with a plurality of keys on the top surface thereof.

In addition, the input device according to an embodiment of the present invention may further include a thumb resting part provided at one side of the thumb keyboard part to allow a user to handle the keys while the thumb is rested thereon.

In addition, in the input device according to an embodiment of the present invention, the four-finger keyboard part may be connected to rotate on the axis with respect to the thumb keyboard part.

In addition, the input device according to an embodiment of the present invention may further include a separation groove provided in the middle of the four-finger keyboard part in the front-rear direction for a user to distinguish a front side key array and a rear side key array on by touching the separation groove.

### Advantageous Effects

According to the present invention, since all five fingers including a thumb can be equally used, compared with performing keyboard input work primarily using only four fingers almost without using the thumb, by providing a thumb keyboard part of a upright wall structure at one side of a four-finger keyboard part and arranging a plurality of keys on the upright wall in correspondence to horizontal movement of the thumb to maximize utilization of the thumb, there is an effect of improving work efficiency according to improvement of keyboard input speed.

### BRIEF DESCRIPTION OF THE DRAWINGS

FIGS. 1 to 4 are views schematically showing an input device according to an embodiment of the present invention.

FIGS. 5 to 8 are views schematically showing an input device according to another embodiment of the present invention.

FIGS. 9 and 10 are views schematically showing an input device according to still another embodiment of the present invention.

FIG. 11 is a view schematically showing a state of mounting a hand connecting piece to the input device of FIG. 9.

DESCRIPTION OF SYMBOLS

| 10: Thumb keyboard part | |
|---|---|
| 11: Key | 12: Thumb resting part |
| 13: Key | 14: Auxiliary extension part |
| 15: Convex protrusion | 16: Bush |
| 20: Four-finger keyboard part | |
| 21: Key | 22: Keyboard main body |
| 23: Connecting rod | 24: Fastener |
| 25: Insertion hole | 26: Penetration hole |
| 30: Thumb keyboard part | |
| 40: Four-finger keyboard part | |
| 41: Separation groove | 42: Coupling groove |
| 50: Ball joint | |
| 60: Thumb keyboard part | |
| 61: Auxiliary extension part | 62: Latch piece |
| 70: Four-finger keyboard part | |
| 71: Separation groove | |
| 80: Hand connecting piece | |
| 81: Rod | 82: Connector |

### BEST MODE FOR CARRYING OUT THE INVENTION

Hereafter, the present invention will be described in detail with reference to the preferred embodiments and the accompanying drawings of the present invention, and it will be described assuming that like reference numerals refer to elements having like functions.

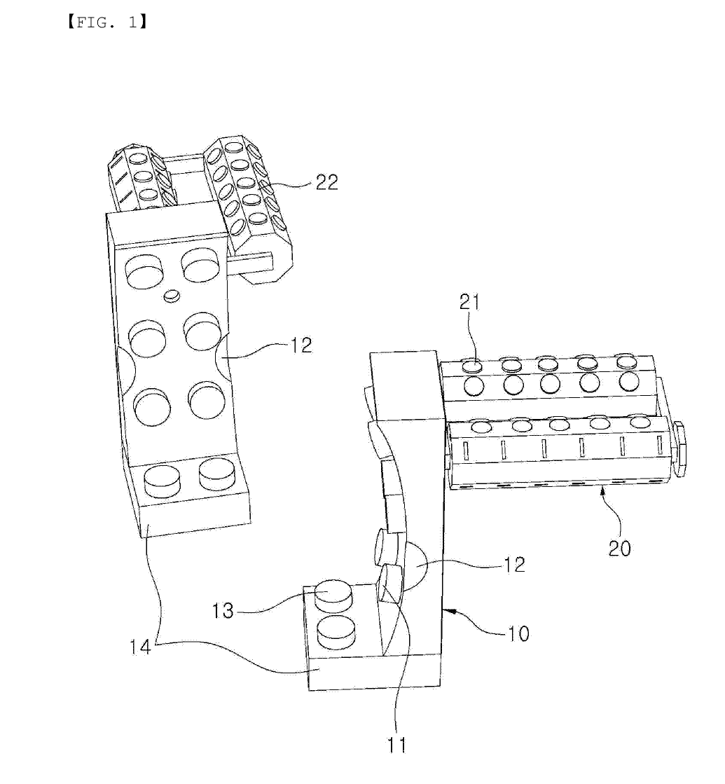

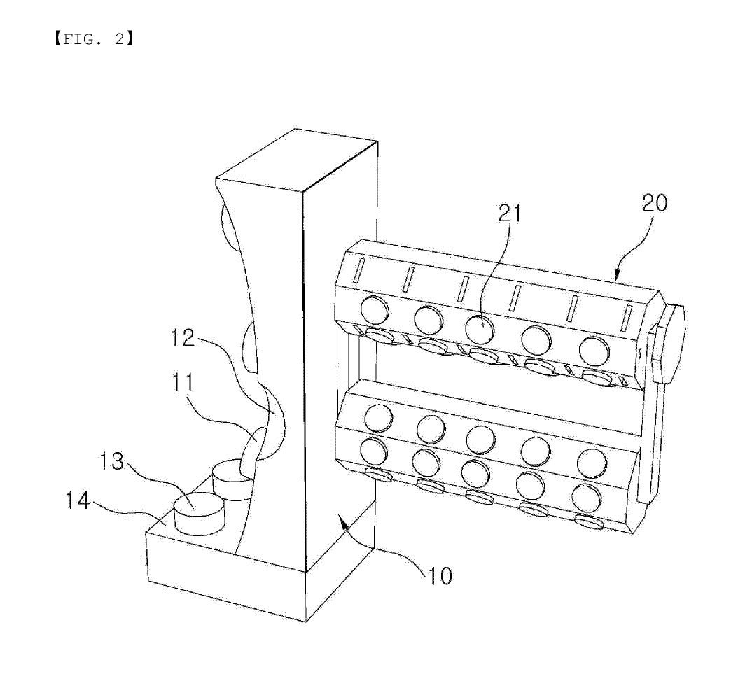

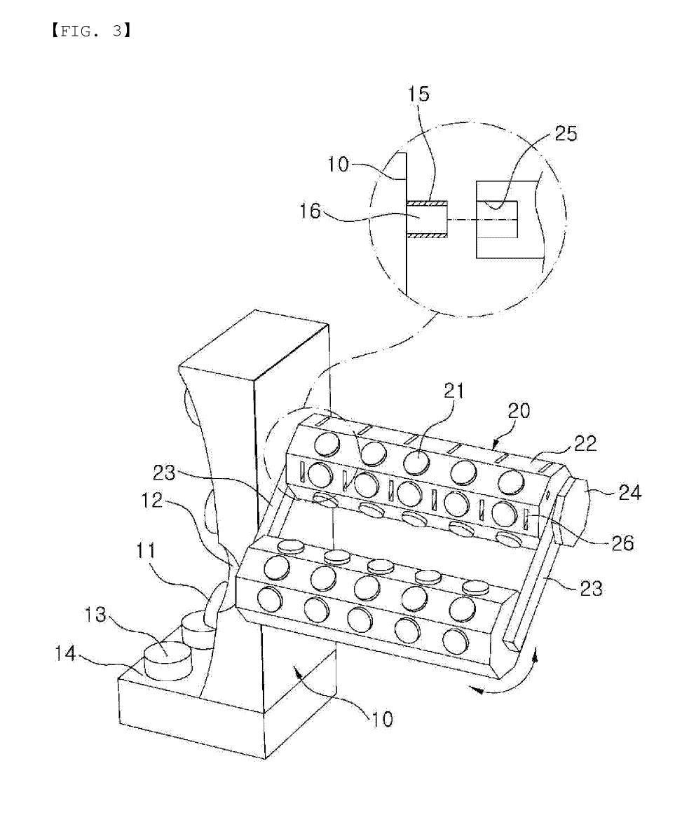

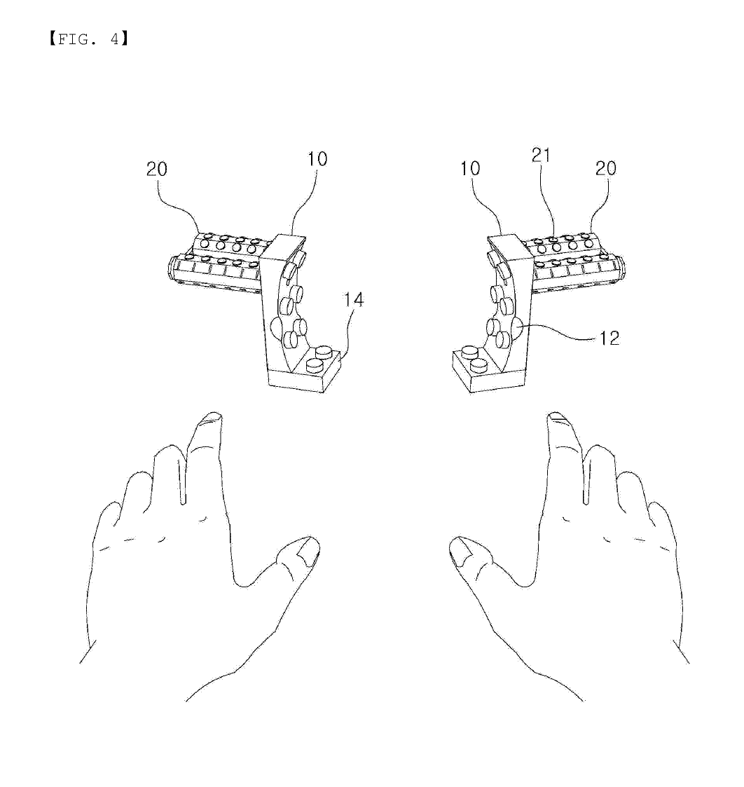

As shown in FIGS. 1 to 4, an input device according to an embodiment of the present invention includes a thumb keyboard part 10 and a four-finger keyboard part 20.

The thumb keyboard part 10 has a plurality of keys 11 provided on a wall surface of an upright wall structure so as to be used only by a thumb to be suitable for the characteristic of the thumb moving in the horizontal direction.

Here, the plurality of keys has an array structure arranging two keys in the horizontal direction and three keys in the vertical direction.

A thumb resting part 12 dented to fit to the shape of the outer circumferential surface of the thumb is provided at one side of the thumb keyboard part 10 contacting with the thumb so that a user may handle the keys while the thumb of the user is rested thereon.

In addition, an auxiliary extension part 14 is provided to be extended from the bottom of the thumb keyboard part 10 in a direction opposite to the four-finger keyboard part 20 and provided with a plurality of keys 13 on the top surface thereof.

Here, the thumb keyboard part 10 and the auxiliary extension part 14 form an L-shape structure. Three two-column keys may be provided in the thumb keyboard part in the vertical direction, and one two-column key may be provided in the auxiliary extension part. Alternatively, two two-column keys may be arranged in both the thumb keyboard part and the auxiliary extension part.

The four-finger keyboard part 20 is connected to one side of the thumb keyboard part 10 to be horizontally extended to the other direction and provided with a plurality of keys 21 on the surface so that only four fingers other than the thumb may be used to be suitable for vertical movement of the four fingers.

Here, the four-finger keyboard part 20 is formed in a structure provided with a pair of keyboard main bodies 22 of approximate octagonal pillar shape and arranging the pair of keyboard main bodies 22 in parallel to be spaced apart from each other by a predetermined distance and connecting both ends of the keyboard main bodies 22 to each other using connecting rods 23.

In addition, the four-finger keyboard part 20 is formed in a structure arranging a plurality of keys 21 on three surfaces among the eight surfaces.

In addition, it is preferable that only the keys on two surface among the three surfaces are applied as practically operating keys.

In this manner, the keys 21 are arranged in a rounded shape in correspondence to the bending shape of four fingers excluding the thumb rather than a structure of spreading the keys 21 in a plate shape, and the keyboard may be handled with various finger postures.

In addition, the connecting rod 23 and the keyboard main body 22 may be fastened using a separate fastener 24 or may be bonded, and various connecting methods may be considered.

In addition, an insertion hole 25 is formed at an end of any one of the keyboard main bodies 22, and a convex protrusion 15 is provided on the rear side of the thumb keyboard part 10 corresponding to the insertion hole. As the convex protrusion 15 is inserted into the insertion hole 25 with interposition of a separate bush 1, the four-finger keyboard part 20 is connected to the thumb keyboard part 10 to rotate on the axis.

As the four-finger keyboard part 20 is provided to rotate on the axis as much as an angle desired by a user, the four-finger keyboard part 20 may be set to a position convenient to use by rotating the four-finger keyboard part 20 on the axis as much as needed according to the position of the hand of the user.

Penetration holes 26 are provided to connect the input device and a separate hand connecting piece (not shown) to each other, and they may be connected using a separate fastener while a penetrating protrusion of a connector of the hand connecting piece is penetrated.

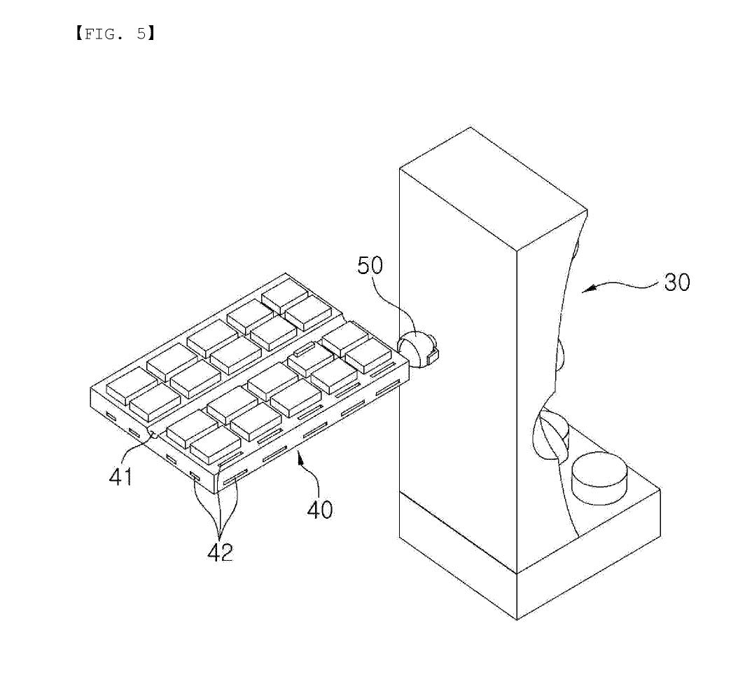

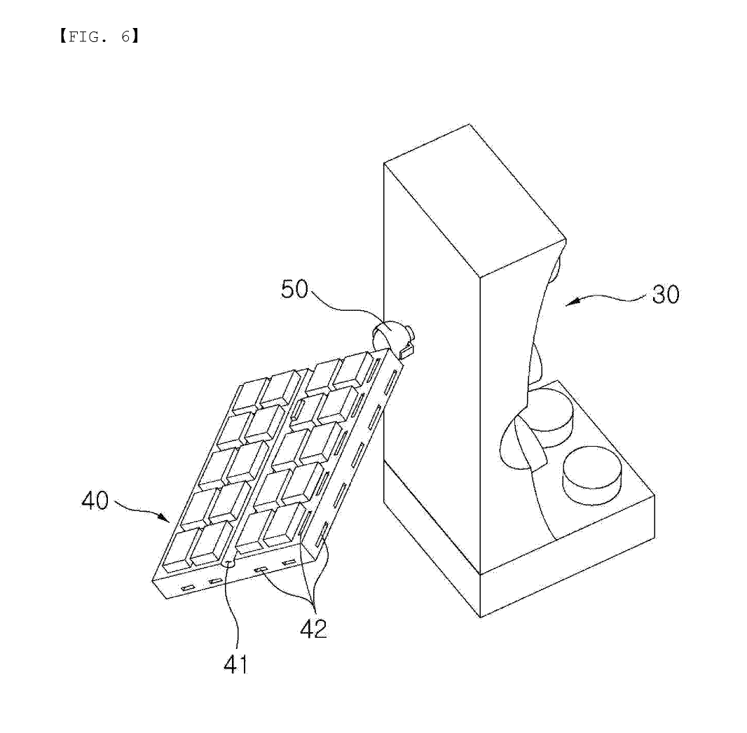

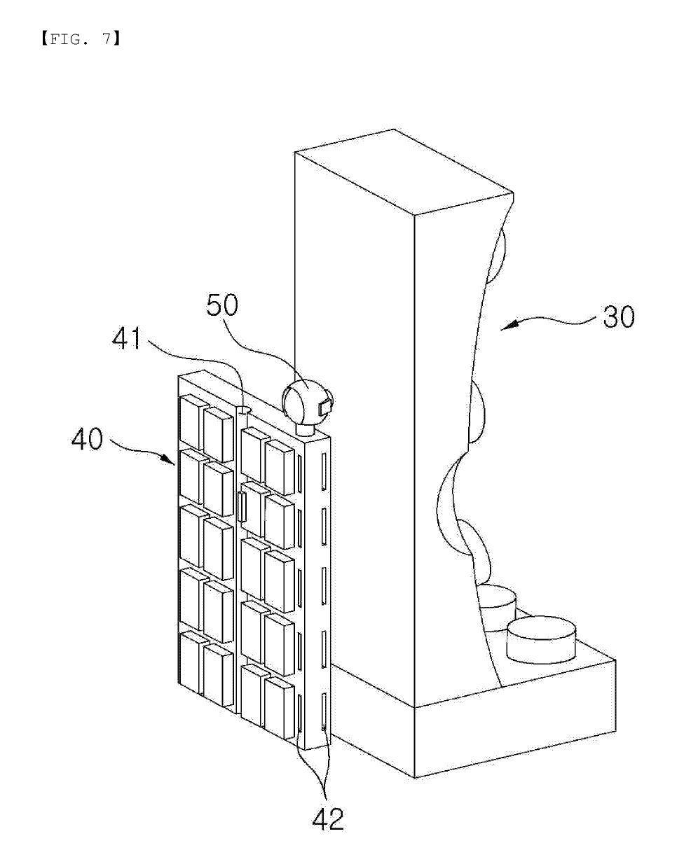

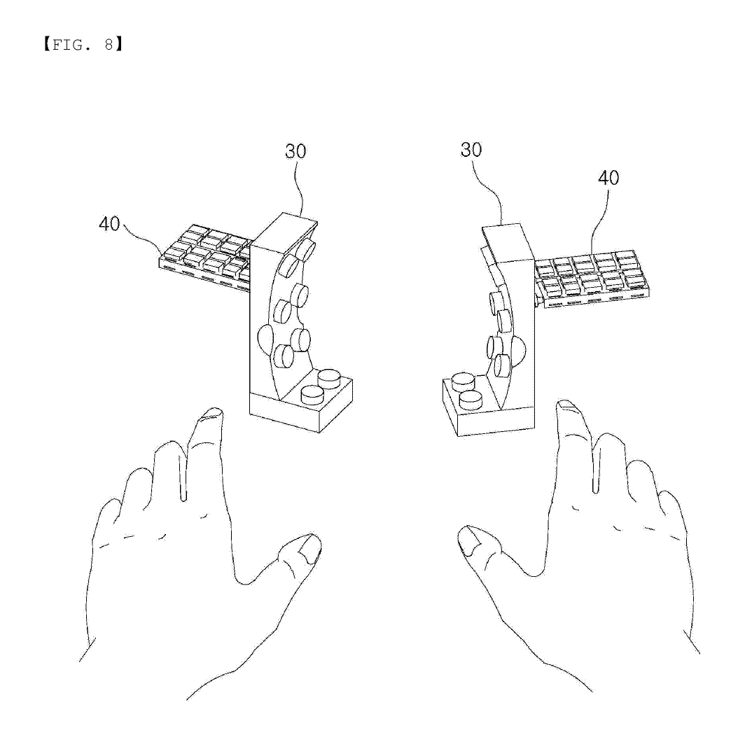

FIGS. 5 to 8 are views showing another embodiment of the present invention, and since an end portion of a rectangular shape four-finger keyboard part 40 is connected on the rear side of a thumb keyboard part 30 using a ball joint 50, the four-finger keyboard part 40 may be folded and unfolded with respect to the thumb keyboard part 30, in addition to performing axial rotation.

In addition, the four-finger keyboard part 40 has a four-column array structure as a key array structure, whereas the thumb keyboard part 30 has a two-column array structure.

In addition, a separation groove 41 for a user to perceive front and rear side key arrays with a sense of a finger is provided in the middle of the four-finger keyboard part 40 to be extended in the front-rear direction.

Coupling grooves 42 are provided to connect the input device and a separate hand connecting piece (not shown), and the input device and the separate hand connecting piece may be coupled by inserting a coupling protrusion of a connector of the hand connecting piece into the coupling groove.

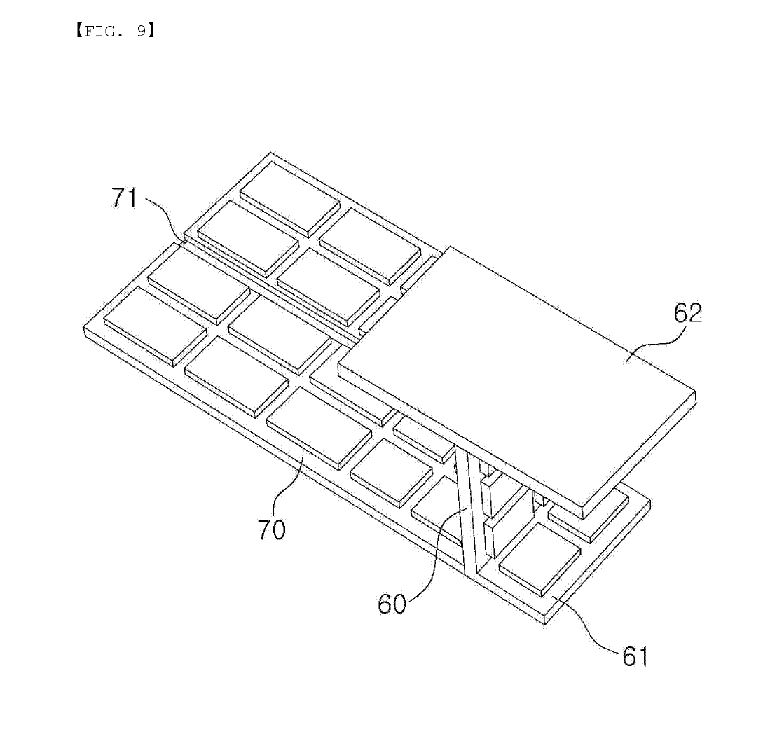

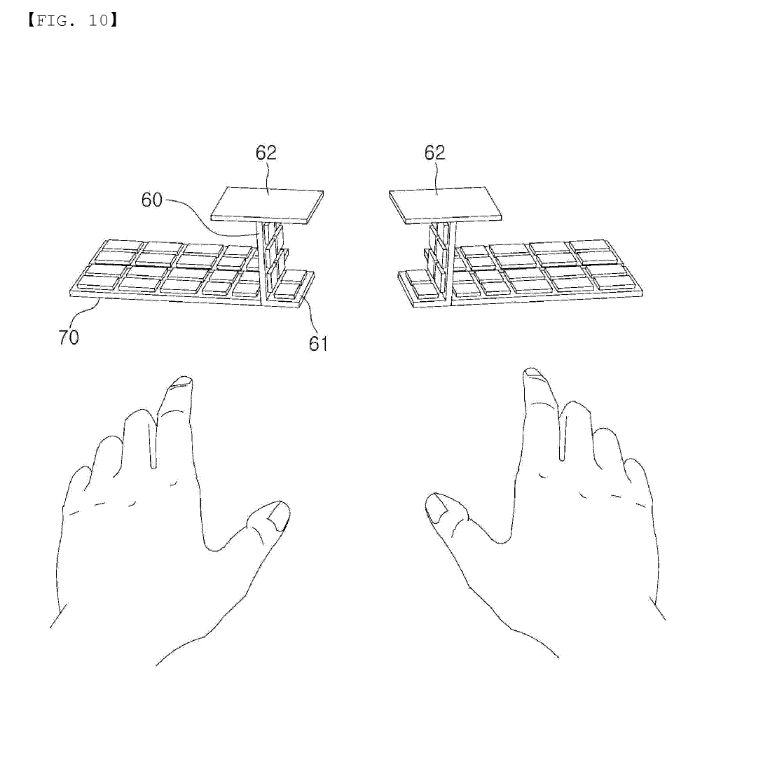

FIGS. 9 and 10 are views showing still another embodiment of the present invention, and here, a thumb keyboard part 60 is formed in a structure of a vertical plate, and a four-finger keyboard part 70 of a plate structure extended from the bottom of the thumb keyboard part 60 to one side and an auxiliary extension part 61 of a plate structure extended from the bottom of the thumb keyboard part 60 in a direction opposite to the four-finger keyboard part 70 are provided.

In addition, the four-finger keyboard part 70 has a four-column array structure as a key array structure, whereas the thumb keyboard part 60 has a two-column array structure.

A separation groove 71 is provided in the middle of the four-finger keyboard part 70 to be extended in the front-rear direction to distinguish a front side key array and a rear side key array on the basis of the separation groove using a sense of a finger.

In addition, the thumb keyboard part 60 is provided with a latch piece 62 for carrying the input device, which is connected on the top in one piece and extended toward both sides.

That is, when a user desires to move the whole input device to a certain location while performing keyboard input work in which the thumb keyboard part 60 is positioned between the thumb and the index finger of the user, if the user raise the hand upward as it is, the latch piece 62 above the hand is latched on the back of the hand and raised upward, and the input device is moved.

Here, the latch piece 62 may be manufactured to be integrated with the top portion of the thumb keyboard part 60 or manufactured to be assembled in a detachable form.

Meanwhile, it will be apparent that a circuit board (not shown) is embedded inside the thumb keyboard part and the four-finger keyboard part of each embodiment of the present invention, and these circuit boards are connected through a wire (not shown) to be electrically connected to each other.

The procedure of using the input device of the present invention according to such a configuration will be described below.

First, a pair of input device parts are prepared to be positioned at the left and right hands of a user.

In addition, keyboard work can be performed by positioning the thumb of the user on the thumb keyboard part 10 and the four fingers of the user on the four-finger keyboard part 20.

In addition, the input device can be conveniently used by rotating the four-finger keyboard part 20 on the axis to a desired position in correspondence to the shape or position of the fingers of the user.

In addition, when the input device is not used, the four-finger keyboard part 40 is bent to be folded with the thumb keyboard part 30 so as to easily keep and carry the input device.

In addition, if the user desires to move the input device while doing keyboard work, the input device may be moved to a desired location while the back of the hand is latched to the latch piece 62 only by raising the hand upward as is.

Meanwhile, it shows a case in which a user uses the input device by putting the input device parts on the top surface of a desk or the like while the input device parts are not combined with the hands of the user, and if separate hand connecting pieces are used, the input device parts are combined with the hands of the user, and thus the user may carry the input device and do the keyboard work even while moving.

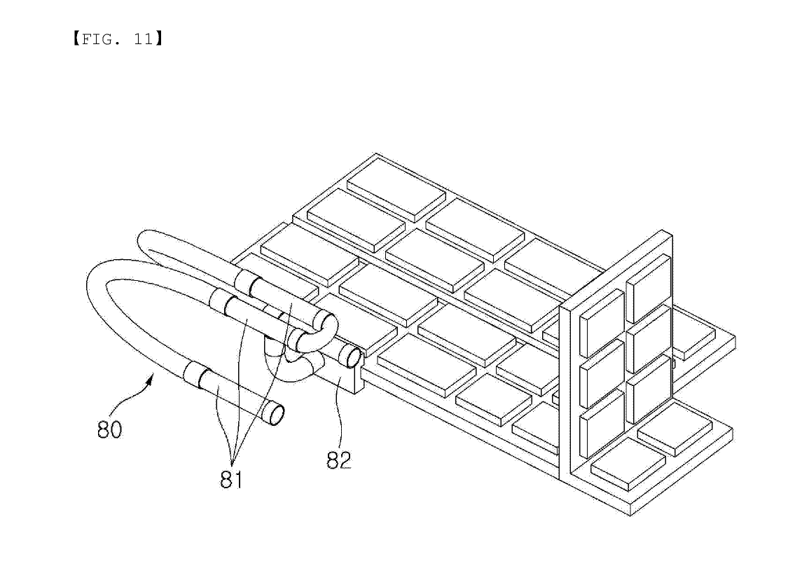

FIG. 11 is a view showing an example of connecting a separate hand connecting piece 80 to the input device of the present invention.

Here, the hand connecting piece 80 is configured by connecting four rods 81 spaced apart from each other by a predetermined distance, and two of the rods 81 are placed on the wrist of the user, and a thick part near the wrist is placed between the other two rods 81, so that a connector 82 of the hand connecting piece 80 is connected to the input device while the hand connecting piece is tightly attached to the hand of the user, and thus the user may do keyboard work while moving in a state of positioning the input device near the hand.

The input device according to the present invention may be connected to various kinds of computing devices and used for key input. For example, the input device may be connected to an IOT (Internet of things) device, an industrial production facility or the like, as well as a personal computer, a smart phone, a tablet computer or the like, and used as a peripheral device for receiving key input from a user.

The technical spirit of the present invention has been described above through several embodiments.

It is apparent that those skilled in the art may modify or change the embodiments described above from the description of the present invention. In addition, although it is not explicitly shown or described, it is apparent that those skilled in the art may make diverse modifications including the spirit of the present invention from the description of the present invention, and this still falls within the scope of the present invention. The embodiments described above with reference to the accompanying drawings are described for illustrative purposes, and the scope of the present invention is not limited to the embodiments.

1. An input device comprising:
a thumb keyboard part dedicated to a thumb and provided with a plurality of keys on a wall surface of an upright wall structure; and
a four-finger keyboard part dedicated to four fingers other than the thumb, connected to one side of the thumb keyboard part, extended to the other direction, and provided with a plurality of keys on a surface,
wherein the four-finger keyboard part is connected to rotate on an axis with respect to the thumb keyboard part.

2. The input device according to claim 1, further comprising an auxiliary extension part extended from a bottom of the thumb keyboard part in a direction opposite to the four-finger keyboard part and provided with a plurality of keys on a top surface thereof.

3. The input device according to claim 1, further comprising a thumb resting part provided at one side of the thumb keyboard part to rest the thumb of a user when the user handles the keys.

4. The input device according to claim 1, further comprising a separation groove provided in a middle of the four-finger keyboard part to be extended in a front-rear direction to distinguish a front side key array and a rear side key array.
